(19) United States
(12) Patent Application Publication
(10) Pub. No.: US 2013/0270778 A1
(43) Pub. Date: Oct. 17, 2013

(54) Clamping device for a cutting tool assembling and disassembling apparatus

(71) Applicant: Chieh-Yuan CHEN, Taichung City (TW)

(72) Inventor: Chieh-Yuan CHEN, Taichung City (TW)

(21) Appl. No.: 13/447,867

(22) Filed: Apr. 16, 2012

(51) Int. Cl. B23B 31/171; B23B 31/22

(52) U.S. Cl. 279/46.7

(57) ABSTRACT

A clamping device for a cutting tool assembling and disassembling apparatus capable of preventing the cutting tool from falling off, comprises: a support seat and a carrying frame rotatably attached to the support seat. A cutting tool carrying seat is fixed on the carrying frame and includes an abutting portion with an abutting surface, a connecting portion to be inserted in the carrying frame, and annular portion. An elastic member is sleeved on the annular portion, in the annular portion are formed two receiving holes for holding a ball, respectively. On an inner surface of the annular portion is formed a flange. A connecting member is sleeved on the annular portion to cover the elastic member, the connecting member includes a slanted surface, below the slanted surface is formed an annular shoulder portion. A ring cover is disposed at a top of the annular portion of the carrying seat.

### BACKGROUND OF THE INVENTION

1. Field of the Invention

The present invention relates to a clamping device for a cutting tool assembling and disassembling apparatus, and more particularly to a clamping device for a cutting tool assembling and disassembling apparatus capable of preventing the cutting tool from falling off.

2. Description of the Prior Art

A conventional tool assembling and disassembling table is normally provided with two holders, one for holding cutting tools in a vertical position, and the other for holding cutting tools in a horizontal position. Since there are various types of cutting tools, different cutting tools might be locked to the holders at different angles. When a cutting tool cannot be disassembled on one of the holders, then it must be moved the other holder, which is troublesome. Besides, the cutting tool is likely to impact the table during movement, as a result, the cutting tool is damaged and therefore unable to closely fit the machine on which the cutting tool is to be assembled.

The present invention has arisen to mitigate and/or obviate the afore-described disadvantages.

### SUMMARY OF THE INVENTION

The primary object of the present invention is to provide a clamping device for a cutting tool assembling and disassembling apparatus capable of preventing the cutting tool from falling off.

To achieve the above object, a clamping device for a cutting tool assembling and disassembling apparatus in accordance with the present invention comprises: a support seat, a carrying frame, a cutting tool carrying seat, and a connecting member.

The carrying frame is rotatably attached to the support seat and formed with a positioning hole.

The cutting tool carrying seat is a hollow structure fixed on the carrying frame and formed with an abutting portion, a connecting portion extending from one side of the abutting portion, and an annular portion extending from another side of the abutting portion. The connecting portion is inserted in the positioning hole, and an elastic member is sleeved on the annular portion. In the annular portion are formed two aligned receiving holes, and in each of the receiving holes is partially received a ball. An inner diameter of an end of the receiving holes at an inner surface of the annular portion is larger than a diameter of the balls, and on an inner surface of the annular portion are formed a flange and two positioning protrusions on the flange.

The connecting member is sleeved on the annular portion of the carrying seat to cover the elastic member which is sleeved on the annular portion. At a top end of the connecting member is formed a slanted surface to push against the balls, and below the slanted surface is formed an annular shoulder portion for pushing against one end of the elastic member.

The cutting tool carrying seat further includes a carrying member received in the cutting tool carrying seat, the carrying member is formed with a flange to be abutted against the flange of the annular portion, the flange of the carrying member is formed with two opposite notches for engaging with the positioning protrusion, and the carrying member is further formed with an inner conical surface for holding a cutting tool.

The cutting tool carrying seat is fixed on the carrying frame by at least one fastener.

The elastic member is a spring.

A plurality of cavities is formed on an outer surface of the connecting member.

A ring cover is disposed at a top of the annular portion of the carrying seat.

The cutting tool carrying seat, the connecting member and the elastic member of the cutting tool assembling and disassembling apparatus cooperate with one another. When the connecting member is pushed to the carrying frame of the tool carrying seat, a space for allowing the balls to move around will be formed between the slanted surface and the outer surface of the abutting portion, so that the cutting tool can be put into the cutting tool carrying seat, and the slanted surface is located outside the receiving holes to prevent the balls falling off the receiving holes. Then, the connecting member will be pushed by the elastic member to move upward. The slanted surface can push the balls to move toward the cutting tool, and the annular shoulder portion makes the balls clip the cutting tool. Hence, when the cutting tool is in a horizontal position, the cutting tool can be fixed from falling off the carrying frame.

### BRIEF DESCRIPTION OF THE DRAWINGS

FIG. 1 is a perspective view of a clamping device for a cutting tool assembling and disassembling apparatus in accordance with the present invention;

FIG. 2 is an exploded view of the clamping device for a cutting tool assembling and disassembling apparatus in accordance with the present invention;

FIG. 3 is a cross sectional view showing the state of the clamping device for a cutting tool assembling and disassembling apparatus in accordance with the present invention before the cutting tool is put on the clamping device;

FIG. 4 is a cross sectional view showing that the cutting tool is being put on the clamping device for a cutting tool assembling and disassembling apparatus in accordance with the present invention; and

FIG. 5 is an operational view showing how to disassemble the cutting tool by using the clamping device for a cutting tool assembling and disassembling apparatus in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

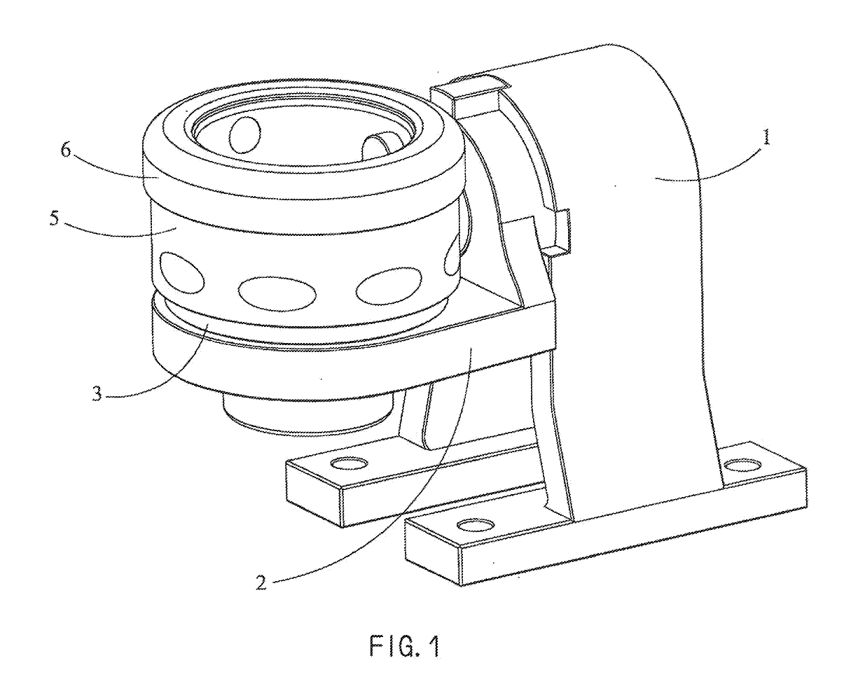

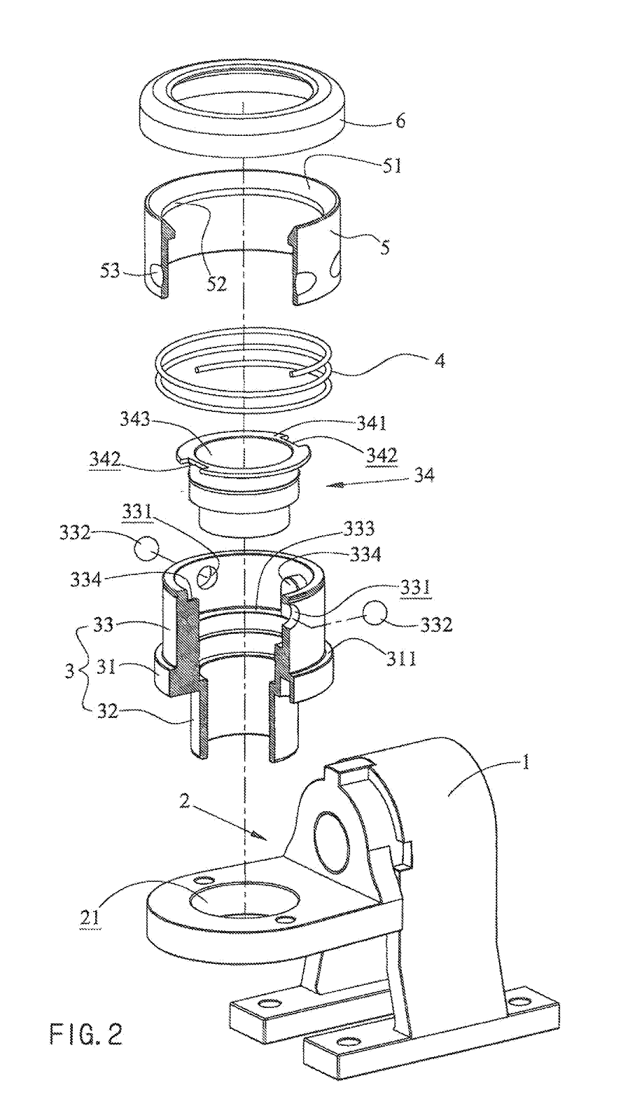

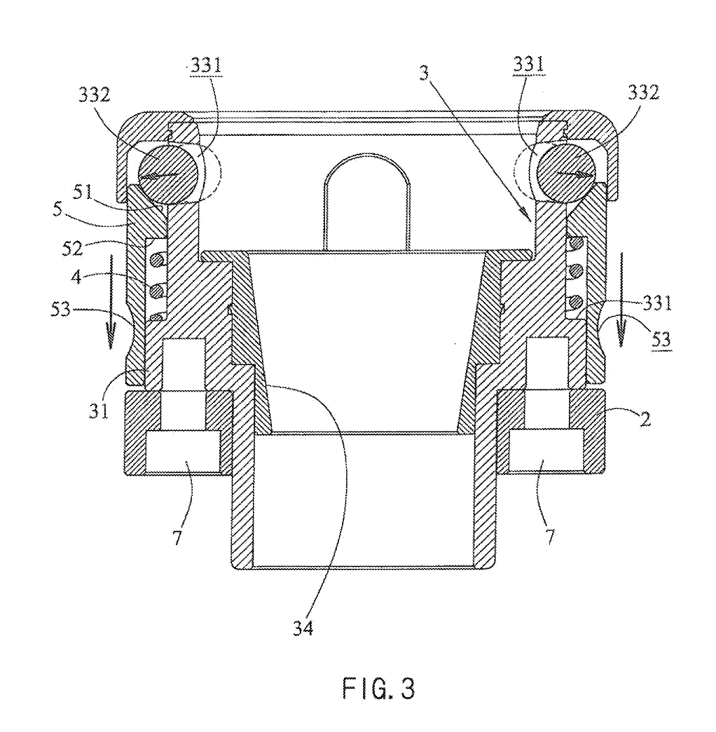

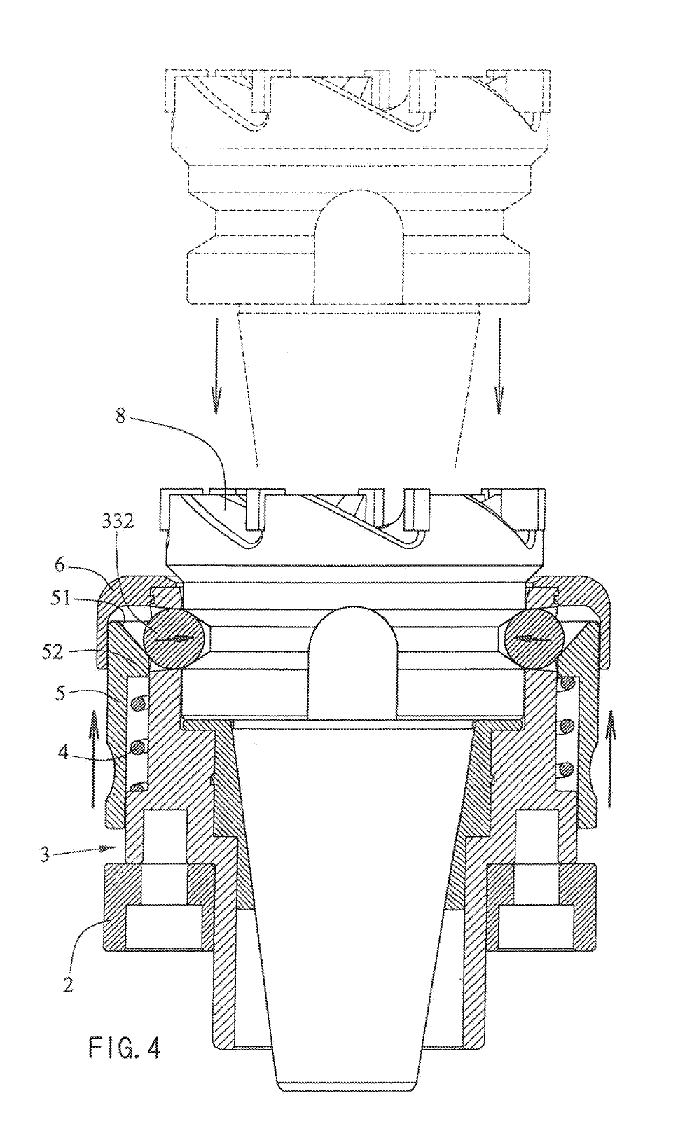

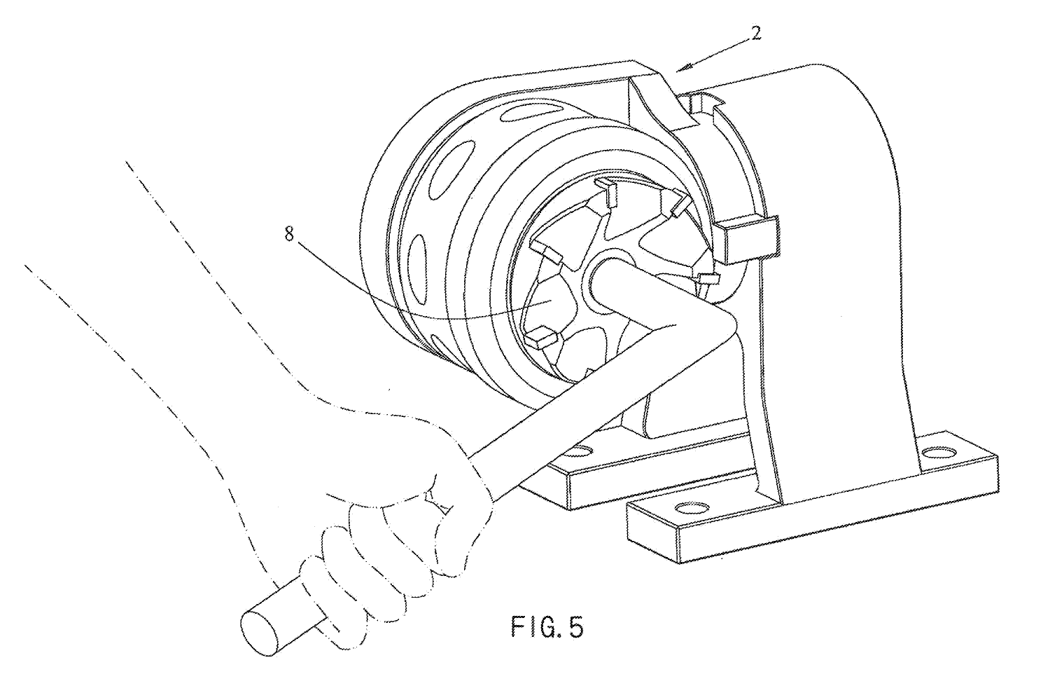

Referring to FIGS. 1-5, a clamping device for a cutting tool assembling and disassembling apparatus in accordance with the present invention comprises: a support seat 1, a carrying frame 2, a cutting tool carrying seat 3, a connecting member 5 and a ring cover 6.

The carrying frame 2 is rotatably attached to the support seat 1 and formed with a positioning hole 21.

The cutting tool carrying seat 3 is a hollow structure fixed on the carrying frame 2 by at least one fastener 7 and formed with an abutting portion 31, a connecting portion 32 extending from one side of the abutting portion 31, and an annular portion 33 extending from another side of the abutting portion 31. The connecting portion 32 is inserted in the positioning hole 21. The abutting portion 31 includes an abutting surface 311. An elastic member 4 which can be a spring is sleeved on the annular portion 33. In the annular portion 33 are formed two aligned receiving holes 331, and in each of the receiving holes 331 is partially received a ball 332. The inner diameter of the end of the receiving holes 331 at the inner surface of the annular portion 33 is larger than the diameter of the balls 332. On the inner surface of the annular portion 33 is formed a flange 333 and two positioning protrusions 334 on the flange 333.

The connecting member 5 is sleeved on the annular portion 33 of the carrying seat 3 and covers the elastic member 4 which is sleeved on the annular portion 33. At the top end of the connecting member 5 is formed a slanted surface 51 to push against the balls 332. Below the slanted surface 51 is formed an annular shoulder portion 52 for pushing against one end of the elastic member 4, and another end of the elastic member 4 is pushed against the abutting surface 311 of the carrying seat 3. On the outer surface of the connecting member 5 is formed a plurality of cavities 53 for facilitating gripping.

The ring cover 6 is disposed at the top of the annular portion 33 of the carrying seat 3 to prevent the connecting member 5 from falling off the annular portion 33.

The cutting tool carrying seat 3 further includes a carrying member 34 received in the cutting tool carrying seat 3. The carrying member 34 is formed with a flange 341 to be abutted against the flange 333 of the annular portion 33. The flange 341 of the carrying member 34 is formed with two opposite notches 342 for engaging with the positioning protrusion 334. The carrying member 34 is further formed with an inner conical surface 343 for holding a cutting tool 8. To disassemble the cutting tool 8, the user can push the connecting member 5 downward by gripping the cavities 53, the annular shoulder portion 52 presses the elastic member 4, and when the connecting member 5 moves to the carrying frame 2, a space for allowing the balls 332 to move around will be formed between the slanted surface 51 and the outer surface of the abutting portion 31, so that the balls 332 won't be restricted by the annular shoulder portion 52 and the slanted surface 51 anymore and will move outward. At this moment, the slanted surface 51 is located outside the receiving holes 331 to prevent the balls 332 falling off the receiving holes 331. Then, the user puts the cutting tool 8 in the carrying member 34 and releases the connecting member 5. The connecting member 5 will be pushed by the elastic member 4 to move upward until stopped by the ring cover 6. The slanted surface 51 can push the balls 332 to move toward the cutting tool 8, and the annular shoulder portion 52 makes the balls 332 clip the cutting tool 8. Hence, when the carrying frame 2 is rotated to make the cutting tool 8 in a horizontal position, the cutting tool 8 can be fixed from falling off the carrying frame 2. Furthermore, the positioning protrusions 334 can prevent the cutting tool 8 from rotating, making it easier for the user to assemble or disassemble the cutting tool 8.

While we have shown and described various embodiments in accordance with the present invention, it is clear to those skilled in the art that further embodiments may be made without departing from the scope of the present invention.

What is claimed is:

1. A clamping device for a cutting tool assembling and disassembling apparatus comprising:
a support seat;
a carrying frame rotatably attached to the support seat and formed with a positioning hole;
a cutting tool carrying seat being a hollow structure fixed on the carrying frame and formed with an abutting portion, a connecting portion extending from one side of the abutting portion, and an annular portion extending from another side of the abutting portion, the abutting portion including an abutting surface, the connecting portion being inserted in the positioning hole, an elastic member being sleeved on the annular portion, in the annular portion being formed two aligned receiving holes, and in each of the receiving holes is partially received a ball, an inner diameter of an end of the receiving holes at an inner surface of the annular portion being larger than a diameter of the balls, on an inner surface of the annular portion being formed a flange and two positioning protrusions on the flange; and
a connecting member sleeved on the annular portion of the carrying seat to cover the elastic member which is sleeved on the annular portion, at a top end of the connecting member being formed a slanted surface to push against the balls, below the slanted surface being formed an annular shoulder portion for pushing against one end of the elastic member.

2. The clamping device for a cutting tool assembling and disassembling apparatus as claimed in claim 1, wherein the cutting tool carrying seat further includes a carrying member received in the cutting tool carrying seat, the carrying member is formed with a flange to be abutted against the flange of the annular portion, the flange of the carrying member is formed with two opposite notches for engaging with the positioning protrusion, and the carrying member is further formed with an inner conical surface for holding a cutting tool.

3. The clamping device for a cutting tool assembling and disassembling apparatus as claimed in claim 1, wherein the cutting tool carrying seat is fixed on the carrying frame by at least one fastener.

4. The clamping device for a cutting tool assembling and disassembling apparatus as claimed in claim 1, wherein the elastic member is a spring.

5. The clamping device for a cutting tool assembling and disassembling apparatus as claimed in claim 1, wherein a plurality of cavities is formed on an outer surface of the connecting member.

6. The clamping device for a cutting tool assembling and disassembling apparatus as claimed in claim 1, wherein a ring cover is disposed at a top of the annular portion of the carrying seat.

7. The clamping device for a cutting tool assembling and disassembling apparatus as claimed in claim 1, wherein a ring cover is disposed at a top of the annular portion of the carrying seat to prevent the connecting member from falling off the annular portion.
